(19) United States
(12) Patent Application Publication
(10) Pub. No.: US 2014/0262719 A1
(43) Pub. Date: Sep. 18, 2014

(54) KEY STRUCTURE

(71) Applicant: CHANGSHU SUNREX TECHNOLOGY CO., LTD., Changshu (CN)

(72) Inventor: Qing ZHANG, Changshu (CN)

(73) Assignee: CHANGSHU SUNREX TECHNOLOGY CO., LTD., Changshu (CN)

(21) Appl. No.: 13/796,269

(22) Filed: Mar. 12, 2013

(51) Int. Cl. H01H 3/12

(52) U.S. Cl. CPC H01H 3/12
USPC 200/517

(57) ABSTRACT

A key structure includes a bottom board having first holes, a membrane circuit board disposed on the bottom board and having second holes that are registered with the first holes, an elastic layer disposed on the membrane circuit board and having third holes that are registered with the second holes, a securing frame, and a key cap. The securing frame is disposed on the elastic layer and has securing members, each extending through a registered set of the third, second and first holes and having an abutting portion abutting against a bottom side of the bottom board to secure the elastic layer, the membrane circuit board, and the bottom board together and closing liquid-tightly the third, second, and first holes.

### BACKGROUND OF THE INVENTION

1. Field of the Invention

The invention relates to a key structure, more particularly to a key structure of a waterproof keyboard.

2. Description of the Related Art

A conventional key structure of a waterproof keyboard includes a bottom board, a membrane circuit board that is disposed on and connected to the bottom board and that has a switch portion thereon, an elastic layer disposed on top of the membrane circuit board and deformable for contacting the switch portion, and a key cap that is disposed on top of the elastic layer and that is downwardly movable to deform the elastic layer for contacting the switch portion and generating a signal while being pressed. A membrane circuit board 11 and an elastic layer 12 of the conventional waterproof key structure are illustrated in FIG. 1. For each key, the membrane circuit board 11 includes a switch portion 14 and a square ring shaped adhesive layer 13 for fixedly attaching the elastic layer 12 on the membrane circuit board 11, so as to prevent liquid from reaching and causing malfunctioned of the switch portion 14.

However, after a long working period, the adhesive layer 13 may crack and be unable to effectively prevent liquid from leaking to the switch portion 14. Therefore, there is a need in the art to provide a key structure that can sustain the waterproof property for a long period of time.

### SUMMARY OF THE INVENTION

Therefore, the object of the present invention is to provide a durable waterproof key structure.

Accordingly, a key structure of the present invention includes:
a bottom board having a plurality of first holes formed separately therethrough in a vertical direction;
a membrane circuit board disposed over and connected to the bottom board and having
   a plurality of second holes formed separately therethrough in the vertical direction, each of the second holes being registered with and larger than a respective one of the first holes, and
   a switch portion formed on the membrane circuit board and surrounded by the second holes;
an elastic layer disposed over and connected to the membrane circuit board, and having a dome portion that covers the switch portion and a plurality of third holes that are formed therethrough in the vertical direction, each of the third holes being registered with and smaller than a respective one of the second holes;
a securing frame having a frame body that is disposed over and connected to the elastic layer and that is formed with an opening, the dome portion of the elastic layer protruding upwardly through the opening, the securing frame further having a plurality of securing members that extend downwardly from the frame body, each of the securing members extending through a respective one of the third holes and a corresponding one of the second and first holes, and having an abutting portion that is formed at a distal end thereof, that has a dimension larger than the respective one of the third holes and that abuts against a bottom side of the bottom board, thereby securing the elastic layer, the membrane circuit board, and the bottom board together and closing liquid-tightly the respective one of the third holes and the corresponding one of the second and first holes; and
a key cap disposed on top of the securing frame, covering the dome portion of the elastic layer and downwardly movable to deform the dome portion for contacting the switch portion of the membrane circuit.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary exploded perspective view of a membrane circuit board and an elastic layer of a conventional waterproof key structure;

FIG. 2 is a perspective view of a preferred embodiment of a key structure according to the present invention;

FIG. 3 is an exploded perspective view of the preferred embodiment of the key structure before abutting portions of a securing frame are formed;

FIG. 4 is another exploded perspective view of the preferred embodiment of the key structure before the abutting portions of the securing frame are formed;

FIG. 5 is a top view of the preferred embodiment;

FIG. 6 is a sectional view of the preferred embodiment before the abutting portions of the securing frame are formed;

FIG. 7 is a sectional view of the preferred embodiment taken along line 7-7 in FIG. 5 and illustrating that the abutting portions are formed and received in receiving grooves of a bottom board; and

FIG. 8 is a sectional view of the preferred embodiment taken along line 8-8 in FIG. 5.

### DETAILED DESCRIPTION OF THE PREFERRED EMBODIMENT

Referring to FIGS. 2, 3, and 4, a preferred embodiment of a key structure for a waterproof keyboard according to the present invention includes a key cap 2, a scissors-type linkage 3, a securing frame 4, an elastic layer 5, a membrane circuit board 6, and a bottom board 7. It should be noted that the waterproof keyboard includes a plurality of the key structures of this invention, the elastic layers 5 of the key structures are integrally interconnected, and so are the membrane circuit boards 6 and the bottom boards 7. Only one key structure will be described in greater detail hereinafter for the sake of brevity.

The bottom board 7 is made of metal and has a board body 71 formed with four first holes 72 separately therethrough in a vertical direction. The bottom board 7 further has four protruding rims 73 formed on a top surface of the board body 71. Each of the protruding rims 73 surrounds a respective one of the first holes 72.

The membrane circuit board 6 is disposed over and connected to the bottom board 7. The membrane circuit board 6 has four second holes 63 formed separately therethrough in the vertical direction, and a switch portion 62 formed on a top surface 61 of the membrane circuit board 6 and surrounded by the second holes 63. Each of the second holes 63 is registered with and larger than a respective one of the first holes 72. The switch portion 62 may be a membrane switch or other triggered switches.

The elastic layer 5 is disposed over and connected to the membrane circuit board 6 and has a dome portion 52 that covers the switch portion 62 and four third holes that are formed therethrough in the vertical direction. Each of the third holes 54 is registered with and smaller than a respective one of the second holes 63, such that each of the protruding rims 73 of the bottom board 7 protrudes upwardly into the respective one of the second holes 63 and abuts liquid-tightly against the elastic layer 5 (see FIG. 7) so as to prevent liquid from leaking through the third holes 54 and reaching the switch portion 62 of the membrane circuit board 6. The dome portion 52 of the elastic layer 5 further has a contact segment 53 protruding downwardly from an inner surface thereof toward the corresponding switch portion 62 of the membrane circuit board 6 for contacting the corresponding switch portion 62 when the dome portion 52 is deformed, thereby causing the corresponding switch portion 62 to generate a signal.

The securing frame 4 has a frame body 41 that is disposed over and connected to the elastic layer 6 and that is formed with an opening 42, such that the dome portion 52 of the elastic layer 5 protrudes upwardly through the opening 42. The securing frame 4 further has a plurality of securing members 43 that are made of a thermoplastic material and that extend downwardly from a bottom surface of the frame body 41. Each of the securing members 43 extends through a respective one of the third holes 54 and a corresponding one of the second and first holes 63 and 72.

As shown in FIG. 8, the key cap 2 is disposed on top of the securing frame 4, covers the dome portion 52 of the elastic layer 5 and is downwardly movable to deform the dome portion 52 for contacting the switch portion 62 of the membrane circuit board 6.

The scissors-type linkage 3 is disposed compressibly under the key cap 2 and interconnects the frame body 41 of the securing frame 4 and the key cap 2.

As shown in FIGS. 5 and 6, the key cap 2, the scissors-type linkage 3, the securing frame 4, the elastic layer 5, the membrane circuit board 6, and the bottom board 7 are stacked in a top-to-bottom order during assembly. Further referring to FIG. 7, each of the securing members 43 of the securing frame 4, after being extended through the respective one of the third holes 54 and the corresponding one of the second and first holes 63 and 72, is formed with an abutting portion 431 at a distal end thereof by deformation from melting. Each of the abutting portions 431 has a dimension larger than the respective one of the third holes 54 and abuts against a bottom side of the bottom board 7, thereby securing the elastic layer 5, the membrane circuit board 6, and the bottom board 7 together and closing liquid-tightly the respective one of the third holes 54 and the corresponding one of the second and first holes 63 and 72. Preferably, the board body 71 of the bottom board 7 is further formed with a plurality of receiving grooves 74 in a bottom surface thereof, and each of the receiving grooves 74 corresponds in position to a respective one of the first holes 72, such that each of the abutting portions 431 is received in a respective one of the receiving grooves 74.

It should be noted that, although four securing members 43 are present in this embodiment, the number of the securing members 43, as well as that of the first, second and third holes 72, 63, and 52, the protruding rims 73, and the receiving grooves 74, is not limited to such in this invention.

To sum up, each of the protruding rims 73 of the bottom board 7 is capable of protruding upwardly into the respective one of the second holes 63 and abutting against the elastic layer 5, so as to prevent liquid from leaking through the third holes 54 and reaching the switch portion 62 of the membrane circuit board 6. Moreover, by utilizing the abutting portions 431 of the securing members 43, the securing frame 4 is able to secure the elastic layer 5, the membrane circuit board 6, and the bottom board 7 together for a relatively long period of time and maintain the leak proof effect for the third holes 54 and the corresponding second and first holes 63 and 72.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A key structure comprising:
a bottom board having a plurality of first holes formed separately therethrough in a vertical direction;
a membrane circuit board disposed over and connected to said bottom board and having
a plurality of second holes formed separately therethrough in the vertical direction, each of said second holes being registered with and larger than a respective one of said first holes, and
a switch portion formed on of said membrane circuit board and surrounded by said second holes;
an elastic layer disposed over and connected to said membrane circuit board, and having a dome portion that covers said switch portion and a plurality of third holes that are formed therethrough in the vertical direction, each of said third holes being registered with and smaller than a respective one of said second holes;
a securing frame having a frame body that is disposed over and connected to said elastic layer and that is formed with an opening, said dome portion of said elastic layer protruding upwardly through said opening, said securing frame further having a plurality of securing members that extend downwardly from said frame body, each of said securing members extending through a respective one of said third holes and a corresponding one of said second and first holes, and having an abutting portion that is formed at a distal end thereof, that has a dimension larger than the respective one of said third holes and that abuts against a bottom side of said bottom board, thereby securing said elastic layer, said membrane circuit board, and said bottom board together and closing liquid-tightly the respective one of said third holes and the corresponding one of said second and first holes; and
a key cap disposed on top of said securing frame, covering said dome portion of said elastic layer and downwardly movable to deform said dome portion for contacting said switch portion of said membrane circuit board.

2. The key structure as claimed in claim 1, wherein said bottom board includes a board body formed with said first holes, and a plurality of protruding rims formed on a top surface of said board body, each of said protruding rims surrounding a respective one of said first holes, protruding upwardly into a corresponding one of said second holes of said membrane circuit board and abutting liquid-tightly against a bottom surface of said elastic layer.

3. The key structure as claimed in claim 2, wherein said board body of said bottom board is further formed with a plurality of receiving grooves in a bottom surface thereof, each of said receiving grooves corresponding in position to a respective one of said first holes and receiving a respective one of said abutting portions of said securing members.

4. The key structure as claimed in claim 1, wherein said dome portion of said elastic layer further has a contact segment protruding downwardly from an inner surface thereof toward said switch portion of said membrane circuit board for contacting said switch portion when said dome portion is deformed.

5. The key structure as claimed in claim 1, further comprising a compressible scissors-type linkage interconnecting said frame body of said securing frame and said key cap.
